(19) United States
(12) Patent Application Publication
(10) Pub. No.: US 2011/0254397 A1
(43) Pub. Date: Oct. 20, 2011

(54) POSITIONING STRUCTURE FOR STATOR ASSEMBLY OF FAN MOTOR

(75) Inventor: CHEN-JUNG CHUANG, Kaohsiung City (TW)

(73) Assignee: ADDA CORPORATION, Kaohsiung City (TW)

(21) Appl. No.: 12/762,332

(22) Filed: Apr. 17, 2010

(51) Int. Cl. H02K 5/00

(52) U.S. Cl. 310/91

(57) ABSTRACT

A positioning structure for a stator assembly of a fan motor has a fan base and a stator assembly. The fan base has a central hub projected thereon for connecting to one end of an axial tube. The fan base is further formed with a plurality of first engagement portions surrounding a hub base of an outer peripheral surface of the central hub. The stator assembly has an axial hole sleeved on the axial tube and a plurality of second engagement portions which can be engaged with the first engagement portions. Thus, the stator assembly can be rapidly and stably installed on the fan base.

### FIELD OF THE INVENTION

The present invention relates to a positioning structure for a stator assembly of a fan motor, and more particularly to a positioning structure for a stator assembly of a fan motor having first engagement portions formed on a fan base and second engagement portions formed on a stator assembly, wherein the first and second engagement portions are engaged with each other to rapidly and stably install the stator assembly on the fan base.

### BACKGROUND OF THE INVENTION

Nowadays, a cooling fan having a heat dissipation function is an important component for a modern electronic product. Various electronic devices are provided in various electronic apparatuses, such as a compact portable computer or a large traffic vehicle. When the electronic devices operate, the electronic devices generally generate heat to cause high temperature, so as to affect the operational performance and even cause the crash thereof. To solve the foregoing problem, the electronic devices are generally installed with a cooling fan to provide a heat dissipation function for lowering the operation temperature, in order to maintain the stable operation of the electronic devices.

Therefore, the reliability and durability of the cooling fan are key factors related to the stable operation of the electronic devices, so that related manufacturers of cooling fans continuously develop various cooling fans to satisfy various different heat dissipation demands. Meanwhile, designs of the cooling fans are improved day by day, to ensure the reliability and durability of the cooling fans. In addition, structures of the cooling fans are simplified to lower the cost of material and installation of the cooling fans.

For example, when installing a stator assembly and a fan base of a traditional cooling fan, fasteners or screwing elements can be used to install the stator assembly on the fan base, or suitable adhesive can be used to attach the stator assembly to the fan base or reinforce the installation strength therebetween. Taiwan Utility Model Patent No. 566757 discloses a positioning structure of a motor stator, wherein the positioning structure comprises a copper axial tube and a positioning ring. The axial tube is formed with a cut groove. The positioning ring is formed with a positioning portion and an engagement portion, wherein the engagement portion is inserted into the cut groove of the axial tube, and the positioning portion is abutted against an upper surface of a coil bobbin of the motor stator, so as to position the motor stator. The technical problem solved by the traditional positioning structure is described, as follows: if the installation strength of the installed motor stator is insufficient, the motor stator may be easily separated from the axial tube due to continuous vibrations under long-term operation. However, there are still some problems existing in the manufacture and installation of the foregoing cooling fan, described, as follows: due to the additional positioning ring, the cost of material and installation will be increased, while the installation process will be more complicated. In addition, the positioning ring is disposed adjacent to an inner wall of a rotor housing of the motor. Thus, if the installation tolerance is not suitably controlled, the positioning ring will be in contact with the inner wall of the rotor housing, so as to cause rotation noise or jam due to friction between the positioning ring and the inner wall.

Therefore, it is necessary to provide a positioning structure for a stator assembly of a fan motor to solve the problems existing in the traditional cooling fans, as described above.

### SUMMARY OF THE INVENTION

A primary object of the present invention is to provide a positioning structure for stator assembly of fan motor, wherein a fan base is formed with a plurality of first engagement portions surrounding a hub base of a central hub, while a stator assembly is correspondingly formed with a plurality of second engagement portions which can be engaged with the first engagement portions. Thus, the stator assembly can be rapidly and stably installed on the fan base for increasing the installation convenience and the installation reliability.

A secondary object of the present invention is to provide a positioning structure for stator assembly of fan motor, wherein second rod sections of the second engagement portions of the stator assembly are inserted into engagement slots of the first engagement portions of the fan base, so as to prevent the stator assembly from being rotated and loosed after installation. Meanwhile, first hook sections of the first engagement portions are engaged with second hook sections of the second engagement portions, so as to prevent the stator assembly from being shifted upward and loosed along an axial direction after installation. Thus, the installation strength and the installation stability can be enhanced.

To achieve the above object, the positioning structure for stator assembly of fan motor of a preferred embodiment of the present invention comprises a fan base and a stator assembly. The fan base has a hollow central hub projected thereon for connecting to one end of an axial tube. The fan base is further formed with a plurality of first engagement portions surrounding a hub base of an outer peripheral surface of the central hub. The stator assembly has an axial hole sleeved on the axial tube and a stator bobbin, wherein a lower portion of the stator bobbin is formed with a plurality of second engagement portions which can be engaged with the first engagement portions. Thus, the stator assembly can be rapidly and stably installed on the fan base.

In one embodiment of the present invention, each of the first engagement portions of the fan base has an engagement slot, a first rod section and a first hook section, while each of the second engagement portions of the stator assembly has a second rod section and a second hook section; and wherein the second rod sections and the second hook sections of the second engagement portions are inserted into the engagement slots of the first engagement portions, and the first hook sections of the first engagement portions are engaged with the second hook sections of the second engagement portions.

In one embodiment of the present invention, each of the first hook sections further comprises a first guiding surface, while each of the second hook sections further comprises a second guiding surface, so that the first and second guiding surfaces guide the first and second hook sections to engage with each other.

In one embodiment of the present invention, each of the first hook sections further comprises a first abutment surface, while each of the second hook sections further comprises a second abutment surface, so that the first and second abutment surfaces are abutted against each other.

In one embodiment of the present invention, the first engagement portions of the fan base are equidistantly arranged around the hub base of the outer peripheral surface of the central hub.

In one embodiment of the present invention, the number of the first engagement portions of the fan base is three, while the number of the second engagement portions of the stator assembly is correspondingly three.

In one embodiment of the present invention, further comprising a printed circuit board sandwiched between the stator bobbin of the stator assembly and the central hub of the fan base, and the printed circuit board has a central hole sleeved on the central hub or the axial tube.

In one embodiment of the present invention, the central hole of the printed circuit board is formed with a plurality of indentations on an inner edge thereof, and the second engagement portions can correspondingly insert into the indentations.

In one embodiment of the present invention, further comprising a rotor assembly which has a rotor housing rotatably covered on the stator assembly, and wherein the rotor housing is provided with an axial shaft inserted into at least one bearing in the axial tube.

### DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective and partially cross-sectional view of a positioning structure for stator assembly of fan motor according to a preferred embodiment of the present invention;

FIG. 2 is a perspective and partially cross-sectional view of a fan base according to the preferred embodiment of the present invention;

FIG. 3 is an assembled perspective view of a stator assembly according to the preferred embodiment of the present invention; and

FIG. 4 is a partially enlarged and assembled cross-sectional view of the positioning structure for stator assembly of fan motor according to the preferred embodiment of the present invention.

### DETAILED DESCRIPTION OF THE PREFERRED EMBODIMENTS

The present invention is related to a positioning structure for stator assembly of fan motor. In the present invention, directional terms (such as upper, lower, inner, outer, axial, radial, longitudinal, transverse and etc.) described hereinafter are defined based on an air inlet side and an air outlet side of a cooling fan motor, wherein the air inlet side is defined as an upper direction, the air outlet side is defined as a lower direction, and other directions are defined according to a normal operation of the cooling fan motor in the accompanying drawings, and these directional terms are only used to describe the installation relationship of relative components of the present invention, but not limited thereto.

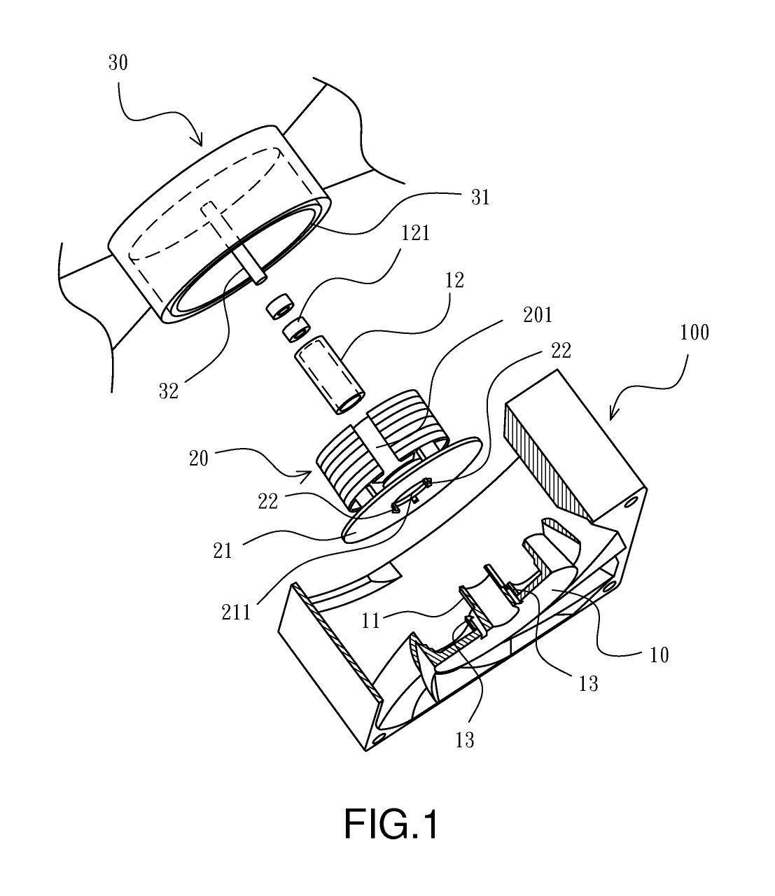

Referring now to FIG. 1, an exploded perspective and partially cross-sectional view of a positioning structure for stator assembly of fan motor according to a preferred embodiment of the present invention is illustrated. As shown, the positioning structure for stator assembly of fan motor comprises a fan base 10 and a stator assembly 20, wherein the stator assembly 20 can be used to install a rotor assembly 30. The fan base 10 is integrally formed on an air outlet side of a housing 100 of a cooling fan, wherein the fan base 10 and the housing 100 are preferably made of durable material, such as plastic or metal. The fan base 10 has a hollow central hub 11 projected on a geometric center thereof. Furthermore, one end of an axial tube 12 is received in and connected to the central hub 11, and at least one bearing 121 is received in the axial tube 12. The fan base 10 is further formed with a plurality of first engagement portions 13 surrounding a hub base of an outer peripheral surface of the central hub 11 (i.e. a connection portion between the fan base 10 and the central hub 11), wherein the first engagement portions 13 are integrally formed on the fan base 10.

Referring now to FIGS. 1, 3 and 4, in the preferred embodiment of the present invention, the stator assembly 20 comprises a stator (unlabeled) constructed by silicon steel sheets (i.e. yokes) and at least one coil, and further comprises a stator bobbin 201 made of insulation material, wherein the stator bobbin 201 has an axial hole 202 which is used to be sleeved on the axial tube 12. The stator bobbin 201 has a lower portion formed with a plurality of second engagement portions 22 corresponding to the first engagement portions 13 of the fan base 10. The lower portion of the stator bobbin 201 is further connected to a printed circuit board 21 which has a central hole 211 on a central portion thereof. The central hole 211 is used to be sleeved on the central hub 11 or the axial tube 12 of the fan base 10. If the axial hole 202 of the stator assembly 20 and the central hole 211 of the printed circuit board 21 have identical inner diameter, the central hole 211 of the printed circuit board 21 is preferably formed with a plurality of indentations 212 on an inner edge thereof, wherein the second engagement portions 22 can correspondingly insert into the indentations 212 and pass through the printed circuit board 21.

Referring still to FIGS. 1, 3 and 4, in the preferred embodiment of the present invention, the stator bobbin 201 is generally constructed by an upper insulation frame and a lower insulation frame (not-shown), both of which are existed structures and are collectively called the stator bobbin 201. The lower portion of the stator bobbin 201 is formed with the second engagement portions 22, wherein the lower portion is the lower insulation frame of the stator bobbin 201, but not limited thereto. For example, the lower portion of the stator bobbin 201 also can be a silicon steel sheet (i.e. yoke), wherein the second engagement portions 22 are metal posts extended outward from the silicon steel sheet (i.e. the lower portion of the stator bobbin 201).

Referring back to FIG. 1, in the preferred embodiment of the present invention, the rotor assembly 30 has a plurality of blades (unlabeled) and a rotor housing 31 which is rotatably covered on the stator assembly 20, and wherein the rotor housing 31 is provided with an axial shaft 32 inserted into at least one bearing 121 in the axial tube 12. Thus, the rotor assembly 30 can rotate in relation to the stator assembly 20 and the fan base 10, so as to drive air flow to flow from an air inlet side to an air outlet side of the housing 100.

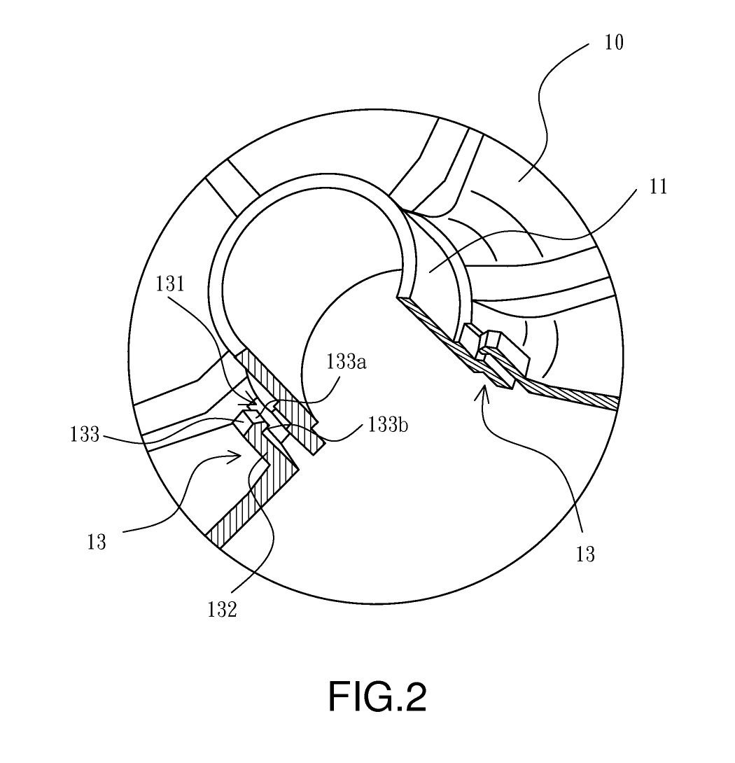

Referring now to FIG. 2, a perspective and partially cross-sectional view of the fan base 10 according to the preferred embodiment of the present invention is illustrated. In the embodiment, the fan base 10 is further formed with a plurality of first engagement portions 13 surrounding a hub base of an outer peripheral surface of the central hub 11, wherein the number of the first engagement portions 13 is preferably three, while the first engagement portions 13 of the fan base 10 are preferably equidistantly arranged around the hub base of the outer peripheral surface of the central hub 11. However, the number of the first engagement portions 13 is not limited to three, i.e. the number thereof can be two, four, five or more. Meanwhile, the first engagement portions 13 of the fan base 10 can be non-equidistantly arranged around the hub base of the outer peripheral surface of the central hub 11. Furthermore, as shown in FIG. 2, each of the first engagement portions 13 of the fan base 10 has an engagement slot 131, a first rod section 132 and a first hook section 133, wherein the first hook section 133 is formed on one distal end of the first rod section 132 and a hook direction of the first hook section 133 faces inward, i.e. toward the engagement slot 131 and the central hub 11. In addition, each of the first hook sections 133 further comprises a first guiding surface 133a and a first abutment surface 133b, wherein the first guiding surface 133a is preferably an inclined surface having an inclined guide angle, while the first abutment surface 133b is preferably a horizontal surface in relation to the surface of the fan base 10. Functions of the first guiding surface 133a and the first abutment surface 133b will be described more detailed hereinafter.

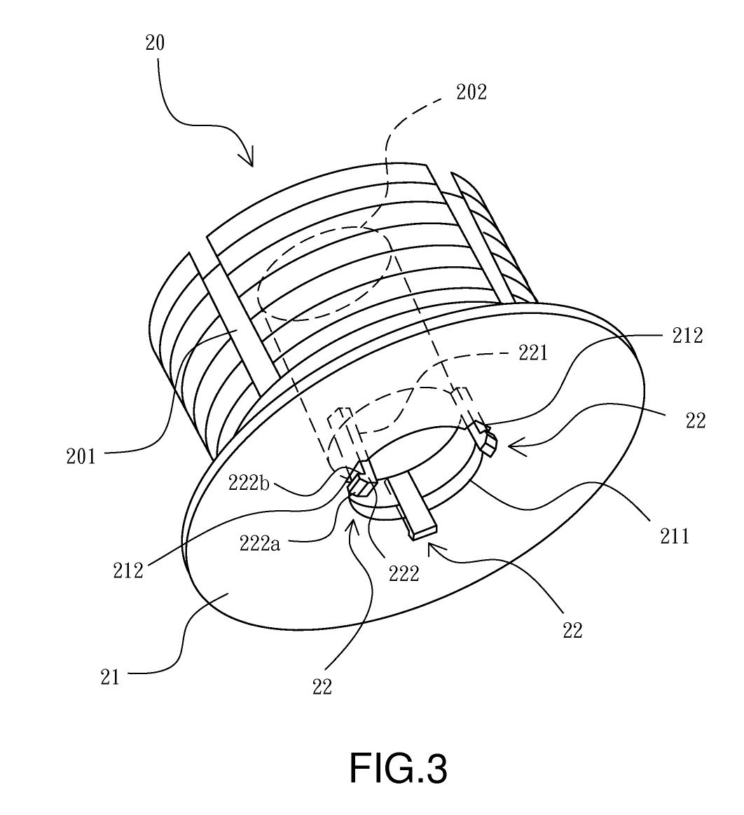

Referring now to FIG. 3, an assembled perspective view of the stator assembly 20 according to the preferred embodiment of the present invention is illustrated. In the embodiment, the lower portion of the stator bobbin 201 of the stator assembly 20 is formed with the second engagement portions 22 which can pass through the indentations 212 of the printed circuit board 21. The number of the second engagement portions 22 of the stator assembly is correspondingly identical to that of the first engagement portions 13. Each of the second engagement portions 22 of the stator assembly 20 has a second rod section 221 and a second hook section 222; and wherein the second hook section 222 is formed on one distal end of the second rod sections 221, while each of the second hook sections 222 is aligned with one set of the engagement slot 131 and the first hook section 133. In the embodiment, the hook direction of the first hook section 133 of the fan base 10 faces inward, while a hook direction of the second hook section 222 correspondingly faces outward. Moreover, each of the second hook sections 222 further comprises a second guiding surface 222a and a second abutment surface 222b, wherein the second guiding surface 222a is preferably an inclined surface having an inclined guide angle, while the second abutment surface 222b is preferably a horizontal surface in relation to the surface of the fan base 10. Functions of the second guiding surface 222a and the second abutment surface 222b will be described more detailed hereinafter.

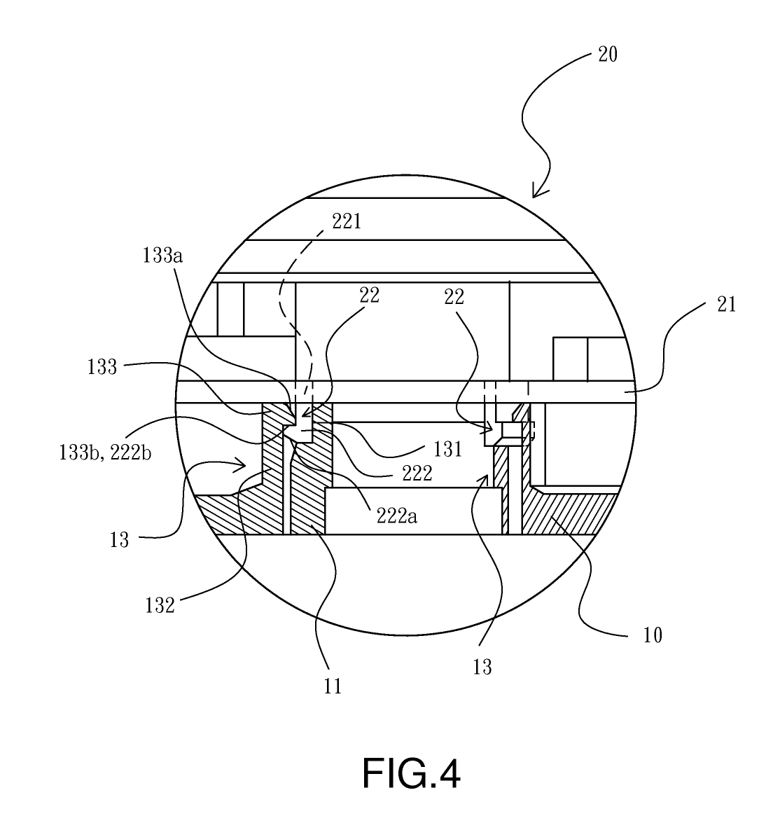

Referring now to FIG. 4, a partially enlarged and assembled cross-sectional view of the positioning structure for stator assembly of fan motor according to the preferred embodiment of the present invention is illustrated. In the embodiment, when the stator assembly 20 is installed on the fan base 10, the stator assembly 20 and the printed circuit board 21 are firstly combined with each other, wherein the second hook section 222 of each of the second engagement portions 22 on the stator bobbin 201 of the stator assembly 20 and a portion of the second rod section 221 thereof are passed downward through each of the indentations 212 of the printed circuit board 21. Then, the combination of the stator assembly 20 and the printed circuit board 21 is sleeved downward on the axial tube 12 on the central hub 11 of the fan base 10, wherein the second rod section 221 of the stator assembly 20 is firstly inserted into the corresponding engagement slot 131 of the first engagement portion 13 on the fan base 10, and then the first hook section 133 of the first engagement portion 13 is engaged with the second hook section 222 of the second engagement portion 22. During the engagement installation, the first guiding surface 133a of the first hook section 133 is bearing against the second guiding surface 222a of the second hook section 222 due to their corresponding inclined guide angles, so that the first rod section 132 of the first engagement portion 13 can be temporarily deformed to radially shift outward a predetermined distance due to the elasticity of its material, while the second rod section 221 of the second engagement portion 22 can be temporarily deformed to radially shift inward a predetermined distance due to the elasticity of its material until the second hook section 222 is abutted against an outer peripheral surface of the axial tube 12 (and/or the central hub 11). When the engagement installation of the second engagement portion 22 and the first engagement portion 13 is finished, the first rod section 132 and the second rod section 221 are returned to their original rod shapes, so that the first abutment surface 133b and the second abutment surface 222b can be abutted against with each other, i.e. the engagement installation of the first hook section 133 of the first engagement portion 13 and the second hook section 222 of the second engagement portions 22 is finished.

Therefore, according to the preferred embodiment of the present invention, the stator assembly 20 can be rapidly and stably installed on the fan base 10. Because the second rod sections 221 of the stator assembly 20 are inserted into and engaged with the engagement slots 131 of the first engagement portion 13 on the fan base 10, so as to prevent the stator assembly 20 from being rotated and loosed after installation. Meanwhile, the first hook sections 133 of the first engagement portions 13 are engaged with the second hook sections 222 of the second engagement portions 22, so as to prevent the stator assembly 20 from being shifted upward and loosed along an axial direction after installation. Thus, the installation strength and the installation stability can be enhanced.

Although each of the first guiding surface 133a and the second guiding surface 222a are preferably an inclined surface having an inclined guide angle, but the present invention is not limited thereto. For example, each of the first guiding surface 133a and the second guiding surface 222a can be a curved surface. In addition, each of the first abutment surface 133b and the second abutment surface 222b are preferably a horizontal surface in relation to the surface of the fan base 10, but the present invention is also not limited thereto. For example, the first abutment surface 133b and the second abutment surface 222b can be corresponding barb surfaces.

As described above, in comparison with the traditional positioning structure for the stator assembly of the fan motor which uses the additional positioning ring to position the stator assembly on the fan base, the positioning structure for stator assembly of fan motor of the present invention as shown in FIGS. 1 to 4 is provided with the first engagement portions 13 surrounding the hub base of the central hub 11 on the fan base 10 and the second engagement portions 22 formed on a lower portion of the stator assembly 20, wherein the second engagement portions 22 can be engaged with the first engagement portions 13. Thus, the stator assembly 20 can be rapidly and stably installed on the fan base 10 for increasing the installation convenience and the installation reliability.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A positioning structure for a stator assembly of a fan motor, comprising:
a fan base having a hollow central hub projected thereon for connecting to one end of an axial tube, the fan base further having a plurality of first engagement portions surrounding a hub base of an outer peripheral surface of the central hub; and
a stator assembly having an axial hole sleeved on the axial tube and a stator bobbin, wherein a lower portion of the stator bobbin is formed with a plurality of second engagement portions which can be engaged with the first engagement portions.

2. The positioning structure for a stator assembly of a fan motor according to claim 1, wherein each of the first engagement portions of the fan base has an engagement slot, a first rod section and a first hook section, while each of the second engagement portions of the stator assembly has a second rod section and a second hook section; and wherein the second rod sections and the second hook sections of the second engagement portions are inserted into the engagement slots of the first engagement portions, and the first hook sections of the first engagement portions are engaged with the second hook sections of the second engagement portions.

3. The positioning structure for a stator assembly of a fan motor according to claim 2, wherein each of the first hook sections further comprises a first guiding surface, while each of the second hook sections further comprises a second guiding surface, so that the first and second guiding surfaces guide the first and second hook sections to engage with each other.

4. The positioning structure for a stator assembly of a fan motor according to claim 2, wherein each of the first hook sections further comprises a first abutment surface, while each of the second hook sections further comprises a second abutment surface, so that the first and second abutment surfaces are abutted against each other.

5. The positioning structure for a stator assembly of a fan motor according to claim 1, wherein the first engagement portions of the fan base are equidistantly arranged around the hub base of the outer peripheral surface of the central hub.

6. The positioning structure for a stator assembly of a fan motor according to claim 5, wherein the number of the first engagement portions of the fan base is three, while the number of the second engagement portions of the stator assembly is correspondingly three.

7. The positioning structure for a stator assembly of a fan motor according to claim 1, further comprising a printed circuit board sandwiched between the stator bobbin of the stator assembly and the central hub of the fan base, and the printed circuit board has a central hole sleeved on the central hub or the axial tube.

8. The positioning structure for a stator assembly of a fan motor according to claim 7, wherein the central hole of the printed circuit board is formed with a plurality of indentations on an inner edge thereof, and the second engagement portions can correspondingly insert into the indentations.

9. The positioning structure for a stator assembly of a fan motor according to claim 1, further comprising a rotor assembly which has a rotor housing rotatably covered on the stator assembly, and wherein the rotor housing is provided with an axial shaft inserted into at least one bearing in the axial tube.
